(19) United States
(12) Patent Application Publication
(10) Pub. No.: US 2003/0077529 A1
(43) Pub. Date: Apr. 24, 2003

(54) Check board replacement systems

(75) Inventor: Paul J. Berndt, Waconia, MN (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(73) Assignee: Honeywell Advanced Circuits, Inc.

(21) Appl. No.: 09/978,893

(22) Filed: Oct. 15, 2001

(51) Int. Cl. G03C 5/00

(52) U.S. Cl. 430/30

(57) ABSTRACT

A method for verifying an imaged article prior to etching comprising: providing the imaged article to be verified, the imaged article comprising an exposed photo resist layer; prior to etching the imaged article, examining the exposed photo resist layer; and making a determination based at least in part on the examination of the photo resist layer whether the imaged article is to be re-imaged.

### FIELD OF THE INVENTION

The field of the invention is photolithography methods and systems.

### BACKGROUND OF THE INVENTION

Creation of a finished printed wiring board/production layer often involves forming a conductive layer of a substrate into a specific pattern. In many instances the conductive layer starts out as a metal/conductive layer on a nonconductive substrate. Forming the conductive layer into a specific pattern often involves coating the conductive layer with an etch resist, transferring a pattern corresponding to the pattern to be formed in the conductive layer onto the resist, and subsequently etching the conductive layer to form it into the transferred pattern. Once conductive layer etching (“etching”) of the substrate is completed, automated optical inspection (“AOI”) systems may be used to verify the accuracy with which the pattern was reproduced on the substrate.

Transferring the pattern from the production artwork to the resist may be accomplished via known methods such as the use of exposure systems for imaging the resist. Exposure systems may be classified as contact printers, laser projection imaging systems, laser direct imaging systems, and step and repeat systems. A brief description of each of these categories can be found in the article Shedding Light on PCB Imaging (herein incorporated by reference in its entirety) by Dr. Kanti Jain and Marc Zemel in the August 2001 issue of PC FAB magazine (http://www.pcfab.com/db_area/archive/2001/0108/zemel.html). Once imaging of the resist is complete, the production layer is transferred to a develop-etch-strip (“DES”) machine for processing. In the DES machine, the resist layer is developed, the production layer is etched to remove unwanted/unprotected portions of metal layers, and residual resist is stripped from the production layer.

After DES processing, the production layer is subjected to inspection and verification processes. Unfortunately, detecting an error in a production layer at this stage results in discarding all or a portion of the production layer because etching has already occurred.

### SUMMARY OF THE INVENTION

The present invention is directed to the detection of defects introduced into productions layers prior to the occurrence of etching or other processing steps which cannot be corrected without discarding all or a portion of a production layer. In particular, measuring fiducials of an exposed resist prior to etching allows for detecting of errors in a production layer at an early enough stage that the all of the layer can be reworked to eliminate the errors. Fiducial measurement may be done after exposure but before development of the resist, or after development of the resist but before etching. Fiducial measurement is accomplished by optically inspecting the resist to measure the distance between fiducials located at dimensional extremes of the production layer.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a diagram of a first method embodying the invention.

FIG. 2 is a diagram of a second method embodying the invention.

FIG. 3 is a diagram of an article bearing an image containing fiducials at its dimensional extremes.

FIG. 4 is a cutaway view of an imaged article prior to development.

FIG. 5 is a cutaway view of an imaged article after development but prior to etching.

### DETAILED DESCRIPTION

As disclosed herein, the claimed methods help to eliminate the need to discard all or portions of production layers containing defects by allowing many of such defects to be detected prior to etching through examination of an imaged, or imaged and developed, resist.

Referring to FIG. 1, a preferred verification process includes step 10, providing an imaged article to be etched, the imaged article comprising an exposed photo resist layer; step 20, prior to etching the imaged article, examining the exposed photo resist layer; and step 30, making a determination based at least in part on the examination of the photo resist layer whether the imaged article is to be re-imaged. In some embodiments, examination of the exposed photo resist layer will occur after exposure and development of the resist layer. Other embodiments may involve examination of the photo resist layer both immediately after imaging of the photo resist layer and immediately after development of the imaged photo resist layer.

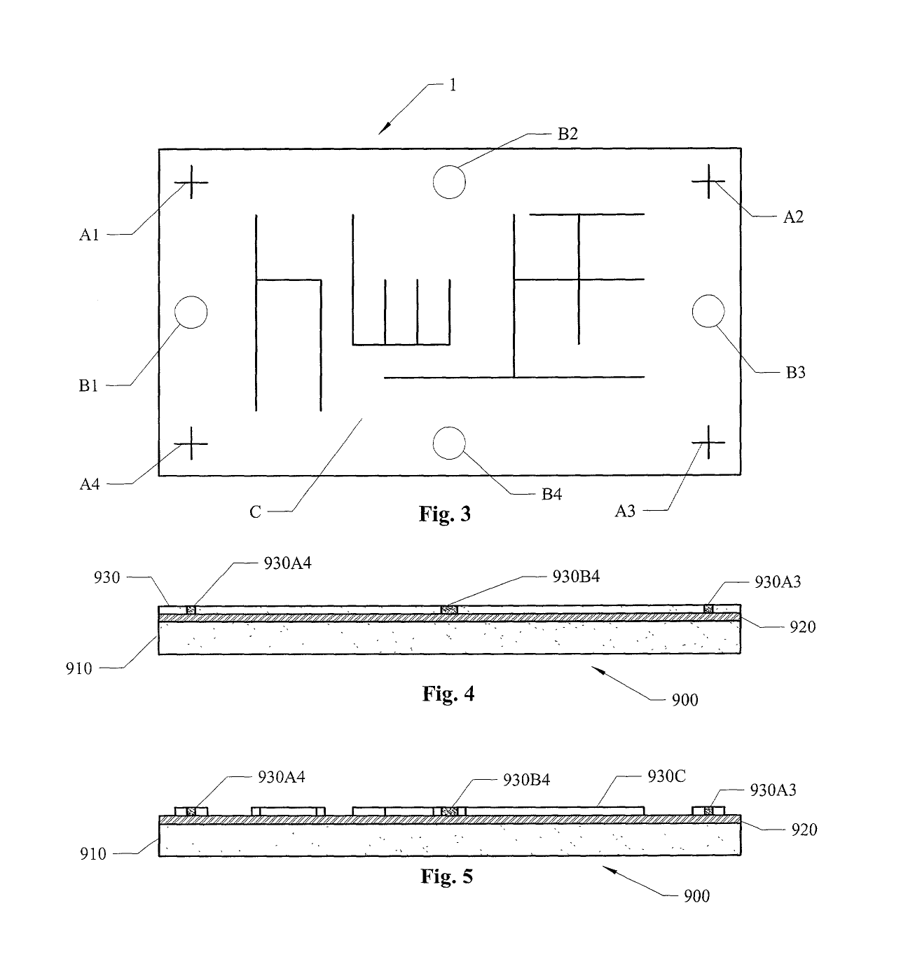

FIGS. 4 and 5 provide examples of an imaged article 900 with FIG. 4 showing such an article prior to development of the resist layer 930 and FIG. 5 showing the article after development of the resist layer 930 but prior to etching of conductive layer 920. Layer 910 is a dielectric layer. Also shown are fiducials 930A4, 930B4, and 930A3 where the fiducials 930A4, 930B4, and 930A3 comprise an exposed portion of resist layer 930.

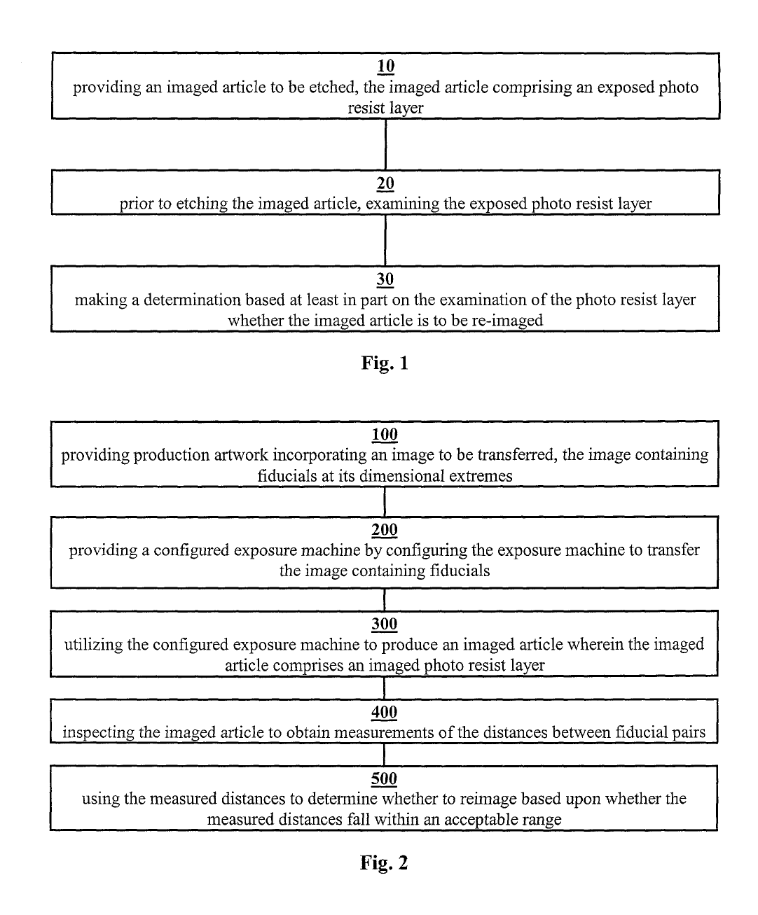

Referring to FIG. 2, an embodiment of the method of FIG. 1 includes step 100, providing production artwork incorporating an image to be transferred, the image containing fiducials at its dimensional extremes; step 200, providing a configured exposure machine by configuring the exposure machine to transfer the image containing fiducials; step 300, utilizing the configured exposure machine to produce an imaged article wherein the imaged article comprises an imaged photo resist layer; step 400, inspecting the imaged article to obtain measurements of the distances between fiducial pairs; step 500, using the measured distances to determine whether to reimage based upon whether the measured distances fall within an acceptable range.

Step 100, providing production artwork incorporating an image to be transferred may be accomplished in any of a number of known ways. One of average skill in the art will realize that any suitable means for providing production artwork may be used with the claimed methods. Depending on the method chosen for transfer, the artwork may exist in various forms such as a laser plotted image for use in a contact printer or projection imaging system, or as a data file in a computer used to drive a laser direct imaging system.

FIG. 3 provides an example of production artwork incorporating an image to be transferred where the image contains fiducials at its dimensional extremes. The term “fiducials” as used herein are simply lines, points or other geometric figures which are part of the image that are identified as being suitable for use in obtaining measurements of locations of and/or distances between features of an imaged article. Such fiducials may be part of a circuit pattern to be etched into a metallized substrate or may be added specifically for measurement purposes. The term “dimensional extremes” as used herein means at or near the outer edges of the artwork being imaged. As can be seen in the figure, fiducials A1, A2, A3, A4, B1, B2, B3, and B4 are located at dimensional extremes of pattern C of article 1. Article 1 could be an article of production artwork, a visual representation of artwork stored as a data file, or a metallized substrate with a photo resist layer.

Step 200, providing a configured exposure may involve installing a physical embodiment of the production artwork in an exposure machine or by transferring one or more data files to the exposure machine. In situations where a physical embodiment of the production artwork is installed, defects introduced into the artwork during installation are frequently the source of errors in the final product. Also, such a physical embodiment of the artwork tends to undergo dimensional changes as a result of humidity and temperature variations. If the artwork actually contacts the production layer during imaging, such contact can also cause defects in the final product. As with step 100, any suitable means for accomplishing this step may be utilized with the known advantages and disadvantages of the various means being considered in deciding which means to use.

Step 300, utilizing the configured exposure machine to produce a first imaged article may be accomplished in any of a number of known ways. One of average skill in the art will realize that any suitable means for utilizing the configured exposure machine to produce a first imaged article may be used with the claimed methods. Such suitable means may include, but are not necessarily limited to, processing a production layer through subsequent processes to yield an imaged article to be inspected.

Step 400, inspecting the imaged article to obtain measurements of the distances between fiducial pairs may be accomplished in any of a number of ways. One of average skill in the art will realize that any suitable means for inspection and verification may be used with the claimed methods, so long as such means permit the measurement of an imaged photo resist before and/or after development of the resist. Such suitable means may include, but are not necessarily limited to the use of automated optical inspection machines and manual verification with stereoscopes. It is preferred that such means facilitate identifying and/or measuring the distance between fiducials.

Step 500, using the measured distances to determine whether to reimage based upon whether the measured distances fall within an acceptable range will generally be a manual step wherein the measured distances are compared to previously determined ranges. If the measured distances are acceptable because they fall within the previously determined ranges, the imaged article will be subjected to further processing to produce a finished article. If the measured distances do not fall within acceptable ranges, the imaged article will be re-worked to eliminate the errors causing the detected dimensional errors. It is contemplated that automated methods may be used to accomplish step 500.

Re-working the article may involve stripping off all of the photo resist layer, supplying new artwork and/or modifying the setup of the exposure machine, applying a new photo resist layer to the article, and re-imaging the article. After re-imaging the article the methods disclosed herein can be applied again.

Thus, specific embodiments and applications of methods for verifying imaged articles have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method for verifying an imaged article prior to etching comprising:
providing the imaged article to be verified, the imaged article comprising an exposed photo resist layer;
prior to etching the imaged article, examining the exposed photo resist layer; and
making a determination based at least in part on the examination of the photo resist layer whether the imaged article is to be re-imaged.

2. The method of claim 1 wherein examination of the exposed photo resist layer occurs after exposure and development of the resist layer.

3. The method of claim 1 wherein examination of the exposed photo resist layer occurs after exposure but before development of the resist layer, and after development of the resist layer but before etching of the imaged article.

4. The method of claim 3 wherein examining the exposed photo resist layer comprises measuring the distance between at least one pair of fiducials located near opposite outside edges of the imaged article.

5. A method for producing imaged articles comprising:
providing production artwork incorporating an image to be transferred, the image containing fiducials at its dimensional extremes;
providing a configured exposure machine by configuring the exposure machine to transfer the image containing fiducials;
utilizing the configured exposure machine to produce an imaged article wherein the imaged article comprises an imaged photo resist layer;
inspecting the imaged article to obtain measurements of the distances between fiducial pairs; and
using the measured distances to determine whether to reimage the photo resist layer based upon whether the measured distances fall within an acceptable range.

6. The method of claim 5 wherein the imaged article is a substrate comprising a metal layer coated with a photoimagable etch resist.
